(19) United States
(12) Patent Application Publication
(10) Pub. No.: US 2024/0233738 A9
(43) Pub. Date: Jul. 11, 2024

(54) APPARATUS FOR ENCODING AND DECODING AUDIO SIGNALS AND METHOD OF OPERATION THEREOF

(71) Applicants: Electronics and Telecommunications Research Institute, Daejeon (KR); Gwangju Institute of Science and Technology, Gwangju (KR)

(72) Inventors: Inseon JANG, Daejeon (KR); Seung Kwon BEACK, Daejeon (KR); Tae Jin LEE, Daejeon (KR); Jongmo SUNG, Daejeon (KR); Woo-taek LIM, Daejeon (KR); Byeongho CHO, Daejeon (KR); Jongwon SHIN, Gwangju (KR)

(73) Assignees: Electronics and Telecommunications Research Institute, Daejeon (KR); Gwangju Institute of Science and Technology, Gwangju (KR)

(21) Appl. No.: 18/358,646

(22) Filed: Jul. 25, 2023

(30) Foreign Application Priority Data
Oct. 24, 2022 (KR) 10-2022-0137280

(51) Int. Cl. G10L 19/02

(52) U.S. Cl. CPC G10L 19/02

(57) ABSTRACT

Provided is an encoding apparatus including a memory configured to store instructions and a processor electrically connected to the memory and configured to execute the instructions, wherein the processor may be configured to perform a plurality of operations, when the instructions are executed by the processor, wherein the plurality of operations may include obtaining an input audio signal, generating an embedded audio signal by embedding signal components of a second frequency band of the input audio signal in a first frequency band of the input audio signal, generating additional information associated with the first frequency band and the second frequency band, generating an encoded audio signal by encoding the embedded audio signal, and formatting the encoded audio signal and the additional information into a bitstream.

### CROSS-REFERENCE TO RELATED APPLICATION

This application claims the benefit of Korean Patent Application No. 10-2022-0137280 filed on Oct. 24, 2022, in the Korean Intellectual Property Office, the entire disclosure of which is incorporated herein by reference for all purposes.

### BACKGROUND

### 1. Field of the Invention

One or more embodiments relate to an apparatus for encoding and decoding audio signals and a method of an operation thereof.

### 2. Description of the Related Art

In an audio codec, a sampling rate may be fixed. In other words, an audio codec may not perform encoding on a signal (e.g., a frequency band) other than a designed frequency band.

In order to encode a signal of a wide frequency band, methods such as downsampling and/or bandwidth extension may be used.

The above description is information the inventor(s) acquired during the course of conceiving the present disclosure, or already possessed at the time, and is not necessarily art publicly known before the present application was filed.

### SUMMARY

Embodiments provide an encoding apparatus that may efficiently compress a wide-band audio signal using a codec operating in a narrow frequency band.

Embodiments provide a decoding apparatus that may output a high-quality audio signal by decoding an encoded audio signal using additional information on an original audio signal.

However, the technical goals are not limited to the above-mentioned technical goals, and other technical goals may exist.

According to an aspect, provided is an encoding apparatus including a memory configured to store instructions and a processor electrically connected to the memory and configured to execute the instructions, wherein the processor may be configured to perform a plurality of operations, when the instructions are executed by the processor, wherein the plurality of operations may include obtaining an input audio signal, generating an embedded audio signal by embedding signal components of a second frequency band of the input audio signal in a first frequency band of the input audio signal, generating additional information associated with the first frequency band and the second frequency band, generating an encoded audio signal by encoding the embedded audio signal, and formatting the encoded audio signal and the additional information into a bitstream.

The first frequency band may include a frequency band having greater energy than the second frequency band.

The generating of the embedded audio signal may include generating the embedded audio signal by folding a spectrum of the second frequency band into the first frequency band based on a boundary frequency of the first frequency band and the second frequency band.

The generating of the embedded audio signal may include based on energy of frequency bins of the first frequency band, generating the embedded audio signal by embedding the signal components of the second frequency band in at least one bin of the frequency bins.

The additional information may include at least one of first information on frequency bands of the first frequency band and the second frequency band, second information on a frequency bin including signal components of the first frequency band and the signal components of the second frequency band, or third information on a degree of mixing of the signal components of the first frequency band and the signal components of the second frequency band.

The additional information may include the at least one information and phase information on the input audio signal.

The third information may include at least one of an energy difference, a phase difference, or a correlation between frequency bands including the signal components of the first frequency band and the signal components of the second frequency band.

According to another aspect, provided is a decoding apparatus including a memory configured to store instructions, and a processor electrically connected to the memory and configured to execute the instructions, wherein the processor may be configured to perform a plurality of operations, when the instructions are executed by the processor, wherein the plurality of operations may include obtaining a bitstream, parsing an encoded audio signal and additional information associated with a first frequency band and a second frequency band of the encoded audio signal from the bitstream, generating an embedded audio signal by decoding the encoded audio signal, separating signal components of the second frequency band embedded in the first frequency band from the embedded audio signal using the additional information, and generating an output audio signal by synthesizing the signal components separated from the embedded audio signal.

The first frequency band may include a frequency band having greater energy than the second frequency band.

The additional information may include at least one of first information on frequency bands of the first frequency band and the second frequency band, second information on a frequency bin including signal components of the first frequency band and the signal components of the second frequency band, or third information on a degree of mixing of the signal components of the first frequency band and the signal components of the second frequency band.

The additional information may include the at least one information and phase information on an original audio signal.

The third information may include at least one of an energy difference, a phase difference, or a correlation between frequency bands including the signal components of the first frequency band and the signal components of the second frequency band.

The separating may include dividing energy of the first frequency band and energy of the second frequency band by a ratio of energies.

According to another aspect, provided is an operating method of an encoding apparatus, the operating method including obtaining an input audio signal, generating an embedded audio signal by embedding signal components of a second frequency band of the input audio signal in a first frequency band of the input audio signal, generating additional information associated with the first frequency band and the second frequency band, generating an encoded audio signal by encoding the embedded audio signal, and formatting the encoded audio signal and the additional information into a bitstream.

The first frequency band may include a frequency band having greater energy than the second frequency band.

The generating of the embedded audio signal may include generating the embedded audio signal by folding a spectrum of the second frequency band into the first frequency band based on a boundary frequency of the first frequency band and the second frequency band.

The generating of the embedded audio signal may include based on energy of frequency bins of the first frequency band, generating the embedded audio signal by embedding the signal components of the second frequency band in at least one bin of the frequency bins.

The additional information may include at least one of first information on frequency bands of the first frequency band and the second frequency band, second information on a frequency bin including signal components of the first frequency band and the signal components of the second frequency band, or third information on a degree of mixing of the signal components of the first frequency band and the signal components of the second frequency band.

The additional information may include the at least one information and phase information on the input audio signal.

The third information may include at least one of an energy difference, a phase difference, or a correlation between frequency bands including the signal components of the first frequency band and the signal components of the second frequency band.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an encoding apparatus according to an embodiment;

FIG. 2 is a flowchart illustrating a method of operating an encoding apparatus, according to an embodiment;

FIG. 3 is a flowchart illustrating an embedding operation of an encoding apparatus, according to an embodiment;

FIG. 4 is a diagram illustrating an embedding operation of an encoding apparatus, according to an embodiment;

FIG. 5 is a diagram illustrating an embedding operation of an encoding apparatus, according to an embodiment;

FIG. 6 is a diagram illustrating a decoding apparatus according to an embodiment;

FIG. 7 is a flowchart illustrating a method of operating a decoding apparatus, according to an embodiment;

FIG. 8 is a flowchart illustrating a separation operation of a decoding apparatus, according to an embodiment;

FIG. 9 is a flowchart illustrating a synthesis operation of a decoding apparatus, according to an embodiment;

FIG. 10 is a schematic block diagram of an encoding apparatus according to an embodiment; and

FIG. 11 is a schematic block diagram of a decoding apparatus according to an embodiment.

### DETAILED DESCRIPTION

The following structural or functional descriptions of embodiments described herein are merely intended for the purpose of describing the embodiments described herein and may be implemented in various forms. However, it should be understood that these embodiments are not construed as limited to the illustrated forms.

Various modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components.

The terminology used herein is for the purpose of describing particular embodiments only and is not to be limiting of the embodiments. As used herein, the singular forms “a,” “an,” and “the” are intended to include the plural forms as well, unless the context clearly indicates otherwise.

As used herein, each of such phrases as “A or B”, “at least one of A and B”, “at least one of A or B”, “A, B or C”, “at least one of A, B and C”, and “at least one of A, B, or C”, may include any one of, or all possible combinations of the items enumerated together in a corresponding one of the phrases. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

The term “-unit” used in the present disclosure refers to a software or a hardware component such as a field programmable gate array (FPGA) or an ASIC, and “-unit” performs certain roles. However, “-unit” is not limited to a software or a hardware. The term “-unit” may be configured to be in an addressable storage medium and may be configured to reproduce one or more processors. For example, “-unit” may include components such as software components, object-oriented software components, class components, and task components, in addition to processes, functions, properties, procedures, subroutines, segments of program codes, drivers, firmware, microcode, circuitry, data, databases, data structures, tables, arrays, and variables. Functions provided within the components and “-units” may be combined into a smaller number of components and “-units” or further separated into additional components and “-units”. Besides, components and “units” may be implemented to play one or more central processing units (CPUs) in a device or a secure multimedia card. In addition, “-unit” may include one or more processors.

Hereinafter, embodiments will be described in detail with reference to the accompanying drawings. When describing the embodiments with reference to the accompanying drawings, like reference numerals refer to like components and a repeated description related thereto will be omitted.

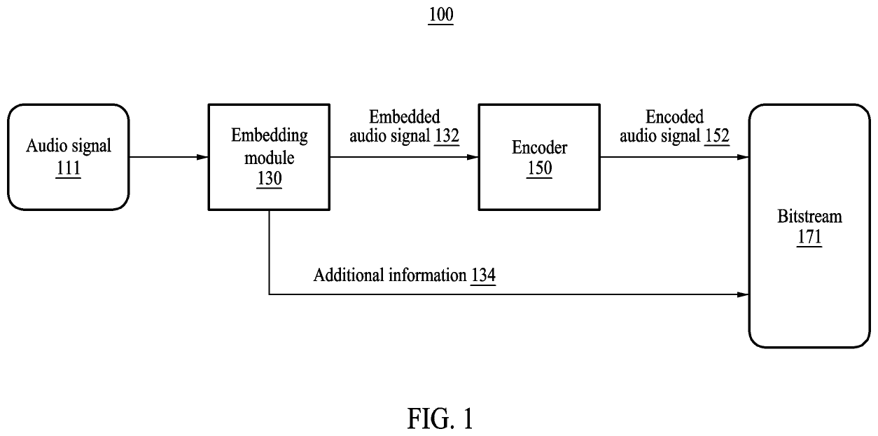

FIG. 1 is a diagram illustrating an encoding apparatus according to an embodiment.

Referring to FIG. 1, according to an embodiment, an encoding apparatus 100 may include an embedding module 130 and an encoder 150 (e.g., an encoding module).

According to an embodiment, an audio signal 111 (e.g., an audio signal with a wide frequency band) may be input to the embedding module 130. The embedding module 130 may selectively embed the audio signal 111. The embedding module 130 may generate an embedded audio signal 132 (e.g., an audio signal with a narrow frequency band) and additional information 134 from the audio signal 111.

According to an embodiment, the encoder 150 may encode the embedded audio signal 132.

According to an embodiment, the encoding apparatus 100 may format an encoded audio signal 152 (e.g., an audio bitstream) and the additional information 134 into a bitstream 171.

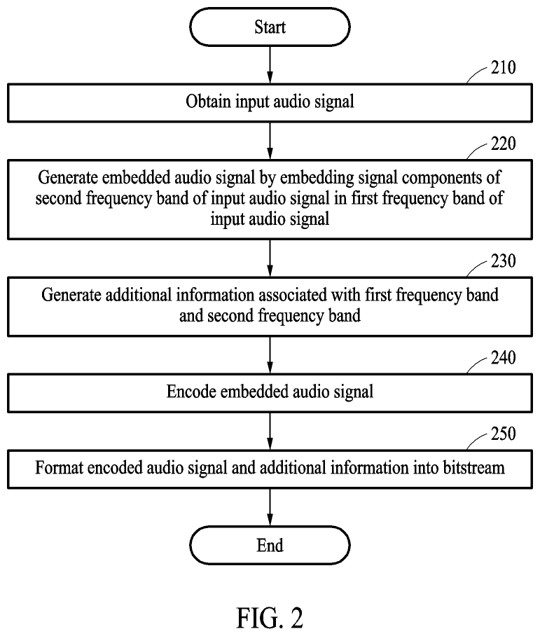

A method of operating the encoding apparatus 100, according to an embodiment, is described in detail with reference to FIGS. 2 to 5.

FIG. 2 is a flowchart illustrating a method of operating an encoding apparatus, according to an embodiment.

Referring to FIG. 2, according to an embodiment, operations 210 to 250 may be sequentially performed but are not limited thereto. For example, operations 220 and 230 may be performed in parallel or the order may be reversed.

In operation 210, an encoding apparatus (e.g., the encoding apparatus 100 of FIG. 1) may obtain an input audio signal (e.g., the audio signal 111 of FIG. 1). The input audio signal 111 may have a frequency band that is wider than a designed frequency band of an audio codec.

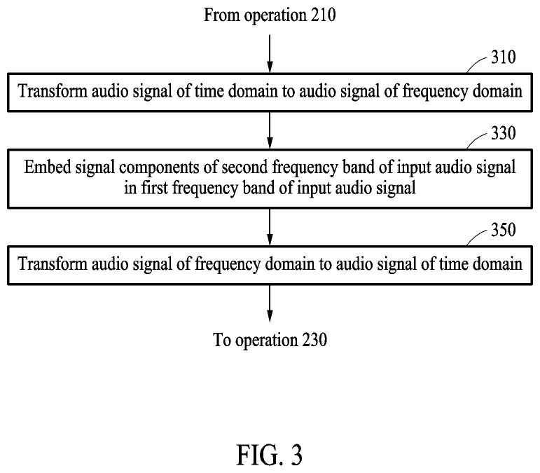

In operation 220, the encoding apparatus 100 may generate the embedded audio signal 132 by embedding signal components of a second frequency band of the input audio signal 111 in a first frequency band of the input audio signal 111. The first frequency band may be a frequency band (e.g., a major frequency band) having greater energy than the second frequency band. The second frequency band may be a frequency band (e.g., a minor frequency band) having smaller energy than the first frequency band. The embedding operation of the encoding apparatus 100 is described in detail with reference to FIGS. 3 to 5.

In operation 230, the encoding apparatus 100 may generate additional information (e.g., the additional information 134 of FIG. 1) associated with the first frequency band and the second frequency band. The additional information 134 may include at least one of first information, second information, or third information. The first information may include information on frequency bands of the first frequency band and the second frequency band. The second information may include information on a frequency bin (or a frequency band) including signal components of the first frequency band and the signal components of the second frequency band. The third information may include information on a degree of mixing of the signal components of the first frequency band and the signal components of the second frequency band. For example, the third information may include the energy difference, phase difference, and correlation between frequency bands including the signal components of the first frequency band and the signal components of the second frequency band. For example, by extracting the energy difference (or the level difference) between frequency bands using a filter bank (e.g., an equivalent rectangular bandwidth (ERB) filter bank), the encoding apparatus 100 may express the third information with a small bit rate.

According to an embodiment, the additional information 134 may further include phase information of the input audio signal 111. For example, the additional information 134 may further include phase information of the input audio signal 111 for each frequency. The encoding apparatus 100 may transmit information (e.g., phase information of the first frequency band) on the first frequency band and by transmitting information on the difference between a phase of the first frequency band and a phase of the second frequency band, may compress and transmit information.

According to an embodiment, the additional information 134 may include information on the difference between the input audio signal 111 and a restored audio signal. For example, by performing encoding (e.g., audio mixing-based encoding) on the input audio signal 111 as well as decoding (e.g., blind sound separation-based decoding), the encoding apparatus 100 may generate information on the difference between the input audio signal 111 and the audio signal restored through the encoding and decoding. The information on the difference between the restored audio signal and the input audio signal 111 generated by the encoding apparatus 100 may be used to compensate for distortion of the restored audio signal by the decoding apparatus (e.g., a decoding apparatus for performing blind sound separation-based decoding).

According to an embodiment, the encoding apparatus 100 may generate an indicator for the additional information 134 and may include the indicator in a bitstream (e.g., the bitstream 171 of FIG. 1) and transmit the indicator.

In operation 240, the encoding apparatus 100 may encode the embedded audio signal 132. The embedded audio signal 132 may have a narrower frequency band than the input audio signal 111.

In operation 250, the encoding apparatus 100 may format the encoded audio signal 152 and the additional information 134 into the bitstream 171.

According to an embodiment, by embedding the signal components of the second frequency band in the first frequency band, the encoding apparatus 100 may efficiently compress a wide-band audio signal (e.g., the input audio signal 111) using a codec operating in a narrow frequency band.

FIG. 3 is a flowchart illustrating an embedding operation of an encoding apparatus, according to an embodiment.

Referring to FIG. 3, according to an embodiment, operations 310 to 350 may be sequentially performed but are not limited thereto. For example, two or more operations thereof may be performed in parallel.

In operation 310, an encoding apparatus (e.g., the encoding apparatus 100 of FIG. 1) may transform an input audio signal (e.g., the audio signal 111 of FIG. 1) of a time domain into an audio signal of a frequency domain. For example, the encoding apparatus 100 may transform the input audio signal 111 into an audio signal of a frequency domain through a discrete Fourier transform.

In operation 330, the encoding apparatus 100 may divide the frequency band of the transformed audio signal (e.g., the input audio signal transformed into the frequency domain in operation 310) into a first frequency band and a second frequency band through spectrum analysis on the transformed audio signal. The first frequency band may be a frequency band (e.g., a major frequency band) having greater energy than the second frequency band. The second frequency band may be a frequency band (e.g., a minor frequency band) having smaller energy than the first frequency band. The encoding apparatus 100 may embed signal components of the second frequency band of the transformed audio signal into the first frequency band of the transformed audio signal.

In operation 350, the encoding apparatus 100 may transform an embedded audio signal (e.g., the signal generated in operation 330) into the audio signal (e.g., the embedded audio signal 132 of FIG. 1) of the time domain. For example, the encoding apparatus 100 may transform the embedded audio signal into the audio signal 132 of the time domain through an inverse discrete Fourier transform.

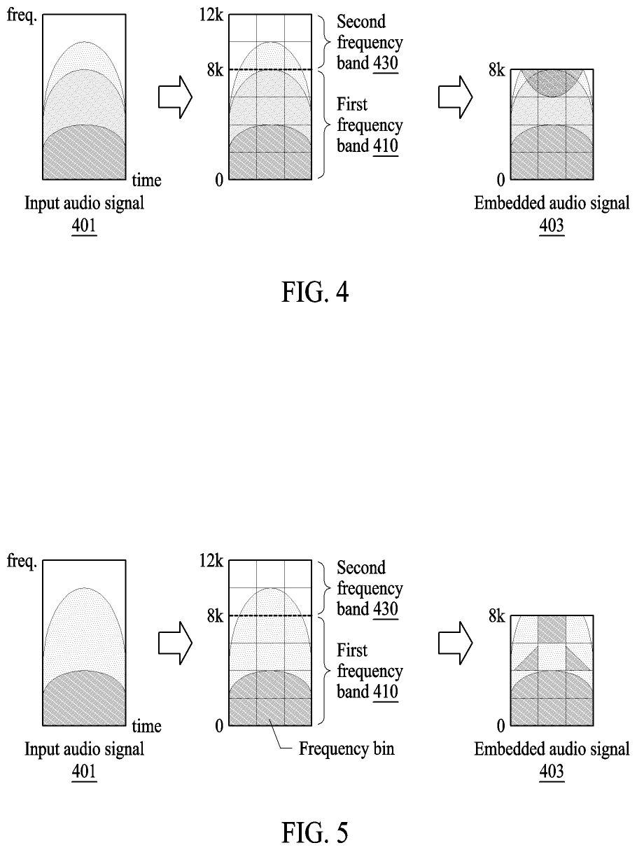

FIG. 4 is a diagram illustrating an embedding operation of an encoding apparatus, according to an embodiment.

Referring to FIG. 4, according to an embodiment, an encoding apparatus (e.g., the encoding apparatus 100 of FIG. 1) may embed signal components of a second frequency band 430 in a first frequency band 410 in various manners. Hereinafter, for convenience of description, a sampling rate of an input audio signal 401 (e.g., the audio signal 111 of FIG. 1) is assumed to be 24 kHz.

According to an embodiment, the encoding apparatus 100 may divide a frequency band of the input audio signal 401 into the first frequency band 410 (e.g., 0 to 8 kHz) and the second frequency band 430 (e.g., 8 to 12 kHz) through spectrum analysis on the input audio signal 401. The bandwidth of the first frequency band 410 and the bandwidth of the second frequency band 430 may be the same or different.

According to an embodiment, the encoding apparatus 100 may generate an embedded audio signal 403 (e.g., the embedded audio signal 132 of FIG. 1) by folding a spectrum of the second frequency band 430 into the first frequency band 410 based on a boundary frequency (e.g., 8 kHz) of the first frequency band 410 and the second frequency band 430. In this specification, folding may refer to an embedding technique for embedding the spectrum of the second frequency band 430 in the first frequency band 410.

According to an embodiment, the sampling rate (e.g., 16 kHz) of the embedded audio signal 403 may be lower than the sampling rate (e.g., 24 kHz) of the input audio signal 401.

According to an embodiment, the encoding apparatus 100 may reduce sound quality deterioration that may occur during a decoding process by embedding signal components of a frequency band (e.g., the second frequency band 430) having small energy in a frequency band (e.g., the first frequency band 410) having large energy.

FIG. 5 is a diagram illustrating an embedding operation of an encoding apparatus, according to an embodiment.

Referring to FIG. 5, according to an embodiment, an encoding apparatus (e.g., the encoding apparatus 100 of FIG. 1) may embed signal components of the second frequency band 430 in the first frequency band 410 based on energy of frequency bins of the first frequency band 410. For example, by selectively embedding signal components of the second frequency band 430 in at least one frequency bin having small energy among frequency bins of the first frequency band 410, the encoding apparatus 100 may generate the embedded audio signal 403 (e.g., the embedded audio signal 132 of FIG. 1). According to an embodiment, in the case of an audio signal (e.g., a music signal) having various acoustic characteristics, the encoding apparatus 100 may embed signal components of the second frequency band 430 having high energy in at least one frequency bin having small energy among frequency bins of the first frequency band 410.

According to an embodiment, by selectively embedding signal components of the second frequency band 430 in at least one frequency bin having small energy among frequency bins of the first frequency band 410, the encoding apparatus 100 may reduce sound quality deterioration that may occur during a decoding process.

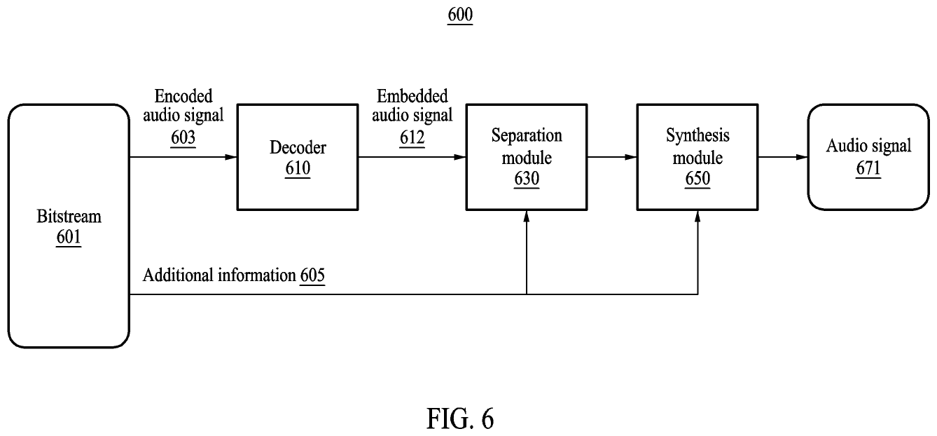

FIG. 6 is a diagram illustrating a decoding apparatus according to an embodiment.

Referring to FIG. 6, according to an embodiment, a decoding apparatus 600 may include a decoder 610 (e.g., a decoding module), a separation module 630, and a synthesis module 650.

According to an embodiment, the decoding apparatus 600 may parse an encoded audio signal 603 (e.g., the encoded audio signal 152 of FIG. 1) and additional information 605 (e.g., the additional information 134 of FIG. 1) from a bitstream 601 (e.g., the bitstream 171 of FIG. 1).

According to an embodiment, the decoder 610 may generate an embedded audio signal 612 (e.g., the embedded audio signal 132 of FIG. 1) by decoding the encoded audio signal 603 (e.g., an audio bitstream).

According to an embodiment, the separation module 630 may separate signal components of the second frequency band (e.g., the second frequency band 430 of FIGS. 4 and 5) embedded in the first frequency band (e.g., the first frequency band 410 of FIGS. 4 and 5) from the embedded audio signal 612.

According to an embodiment, the synthesis module 650 may output an audio signal 671 by synthesizing the signal components (e.g., the signal components of the first frequency band 410 and the signal components of the second frequency band 430) separated from the embedded audio signal 612.

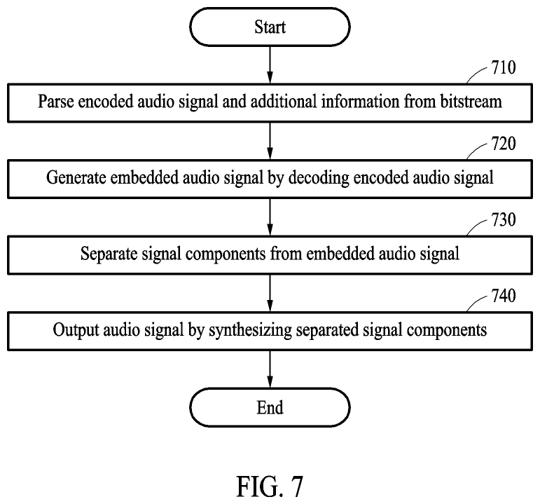

A method of operating the decoding apparatus 600, according to an embodiment, is described in detail with reference to FIGS. 7 to 9.

FIG. 7 is a flowchart illustrating a method of operating a decoding apparatus, according to an embodiment.

Referring to FIG. 7, according to an embodiment, operations 710 to 740 may be sequentially performed but are not limited thereto. For example, two or more operations may be performed in parallel.

In operation 710, a decoding apparatus (e.g., the decoding apparatus 600 of FIG. 6) may parse an encoded audio signal (e.g., the encoded audio signal 603 of FIG. 6) and additional information (e.g., the additional information 605 of FIG. 6) from a bitstream (e.g., the bitstream 601 of FIG. 6). The encoded audio signal 603 may be an audio bitstream. The additional information 605 may be substantially the same as additional information (e.g., the additional information 134 of FIG. 1) generated by an encoding apparatus (e.g., the encoding apparatus 100 of FIG. 1). A repeated description thereof is omitted.

In operation 720, the decoding apparatus 600 may generate an embedded audio signal (e.g., the embedded audio signal 612 of FIG. 6) by decoding the encoded audio signal (e.g., the encoded audio signal 603 of FIG. 6).

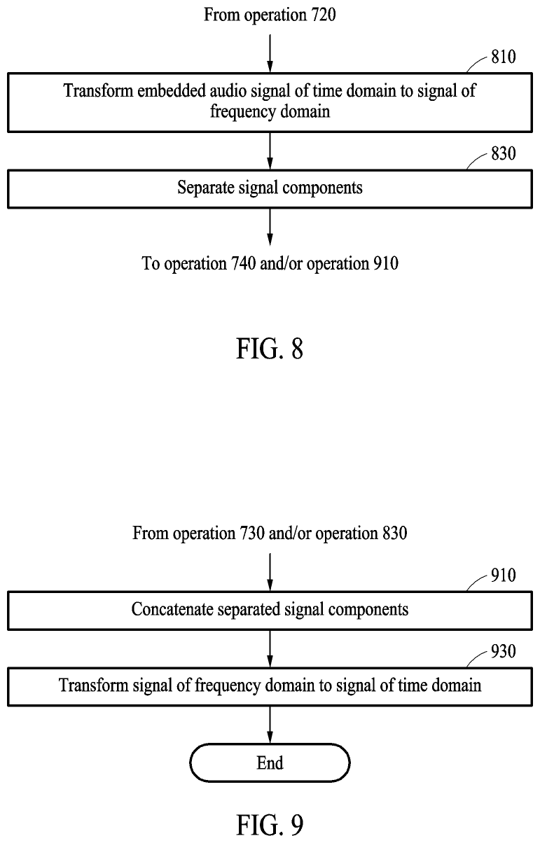

In operation 730, the decoding apparatus 600 may separate signal components of a second frequency band (e.g., the second frequency band 430 of FIGS. 4 and 5) embedded in a first frequency band (e.g., the first frequency band 410 of FIGS. 4 and 5) from the embedded audio signal 612 using the additional information 605. The separating operation of the decoding apparatus 600 is described in detail with reference to FIG. 8.

In operation 740, the decoding apparatus 600 may output an audio signal (e.g., the audio signal 671 of FIG. 6) by synthesizing the separated signal components (e.g., the signal components of the first frequency band 410 and the signal components of the second frequency band 430). The synthesizing operation of the decoding apparatus 600 is described in detail with reference to FIG. 9.

According to an embodiment, the decoding apparatus 600 may output the audio signal 671 of high quality by decoding an encoded audio signal 603 using the additional information 605 on an original audio signal (e.g., the audio signal 111 of FIG. 1).

FIG. 8 is a flowchart illustrating a separation operation of a decoding apparatus, according to an embodiment.

Referring to FIG. 8, according to an embodiment, operations 810 and 830 may be sequentially performed but are not limited thereto. For example, operations 810 and 830 may be performed in parallel.

In operation 810, a decoding apparatus (e.g., the decoding apparatus 600 of FIG. 6) may transform an embedded audio signal (e.g., the embedded audio signal 612 of FIG. 6) of a time domain into an audio signal of a frequency domain. For example, the decoding apparatus 600 may transform the embedded audio signal 612 into the audio signal of the frequency domain through a discrete Fourier transform.

In operation 830, the decoding apparatus 600 may separate signal components of a second frequency band (e.g., the second frequency band 430 of FIGS. 4 and 5) embedded in a first frequency band (e.g., the first frequency band 410 of FIGS. 4 and 5) from an audio signal (e.g., the audio signal transformed in operation 810) of the frequency domain using additional information (e.g., the additional information 605 of FIG. 6). For example, by dividing energy of the first frequency band 410 and energy of the second frequency band 430 by a ratio of energies, the decoding apparatus 600 may extract the signal components of the first frequency band 410 and the signal components of the second frequency band 430.

FIG. 9 is a flowchart illustrating a synthesis operation of a decoding apparatus according to an embodiment.

Referring to FIG. 9, according to an embodiment, operations 910 and 930 may be sequentially performed but are not limited thereto. For example, operations 910 and 930 may be performed in parallel.

In operation 910, a decoding apparatus (e.g., the decoding apparatus 600 of FIG. 6) may concatenate separated signal components (e.g., the separated signal components in operation 730 of FIG. 7 and/or the separated signal components in operation 830 of FIG. 8). For example, by arranging signal components of the first frequency band (e.g., the first frequency band 410 of FIGS. 4 and 5) and signal components of the second frequency band (e.g., the second frequency band 430 of FIGS. 4 and 5) using additional information (e.g., the additional information 605 of FIG. 6), the decoding apparatus 600 may synthesize a spectrum of an audio signal (e.g., an audio signal having a wide frequency band).

In operation 930, the decoding apparatus 600 may transform an audio signal (e.g., the audio signal synthesized in operation 910) of a frequency domain into an audio signal (e.g., the audio signal 671 of FIG. 6) of a time domain. For example, the decoding apparatus 600 may transform the audio signal of the frequency domain into the audio signal 671 of the time domain through an inverse discrete Fourier transform. The decoding apparatus 600 may transform the audio signal of the frequency domain into the audio signal 671 of the time domain using the additional information 605 (e.g., the phase information of the audio signal 111 of FIG. 1).

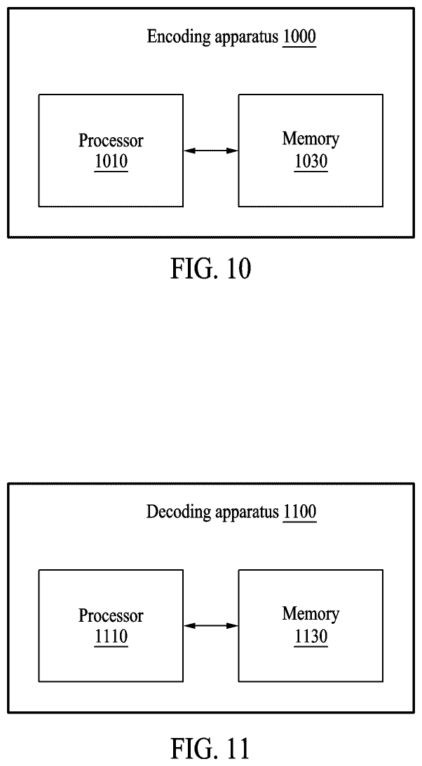

FIG. 10 is a schematic block diagram of an encoding apparatus according to an embodiment.

Referring to FIG. 10, according to an embodiment, an encoding apparatus 1000 (e.g., the encoding apparatus 100 of FIG. 1) may include a memory 1030 and a processor 1010.

The memory 1030 may store instructions (or programs) that may be executed by the processor 1010. For example, the instructions may include instructions for executing an operation of the processor 1010 and/or an operation of each component of the processor 1010.

The processor 1010 may process data stored in the memory 1030. The processor 1010 may execute computer-readable code (e.g., software) stored in the memory 1030 and instructions invoked by the processor 1010.

The processor 1010 may be a data processing unit implemented in hardware with a circuit having a physical structure for executing desired operations. For example, the desired operations may include code or instructions in a program.

For example, the data processing unit implemented in hardware may include a microprocessor, a central processing unit, a processor core, a multi-core processor, a multiprocessor, an ASIC, and an FPGA.

Operations performed by the processor 1010 may be substantially the same as the operations of the encoding apparatus 100 described with reference to FIGS. 1 to 5. Accordingly, detailed descriptions thereof are omitted.

FIG. 11 is a schematic block diagram of a decoding apparatus according to an embodiment.

Referring to FIG. 11, according to an embodiment, a decoding apparatus 1100 (e.g., the decoding apparatus 600 of FIG. 6) may include a memory 1130 and a processor 1110.

The memory 1130 may store instructions (or programs) that may be executed by the processor 1110. For example, the instructions may include instructions for executing an operation of the processor 1110 and/or an operation of each component of the processor 1110.

The processor 1110 may process data stored in the memory 1130. The processor 1110 may execute computer-readable code (e.g., software) stored in the memory 1130 and instructions invoked by the processor 1110.

The processor 1110 may be a data processing unit implemented in hardware with a circuit having a physical structure for executing desired operations. For example, the desired operations may include code or instructions in a program.

For example, the data processing unit implemented in hardware may include a microprocessor, a central processing unit, a processor core, a multi-core processor, a multiprocessor, an ASIC, and an FPGA.

Operations performed by the processor 1110 may be substantially the same as the operations of the decoding apparatus 600 described with reference to FIGS. 6 to 9. Accordingly, detailed descriptions thereof are omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The examples described herein may be implemented using hardware components, software components and/or combinations thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An encoding apparatus comprising:
a memory configured to store instructions; and
a processor electrically connected to the memory and configured to execute the instructions,
wherein the processor is configured to perform a plurality of operations, when the instructions are executed by the processor,
wherein the plurality of operations comprises:
obtaining an input audio signal;
generating an embedded audio signal by embedding signal components of a second frequency band of the input audio signal in a first frequency band of the input audio signal;
generating additional information associated with the first frequency band and the second frequency band;
generating an encoded audio signal by encoding the embedded audio signal; and
formatting the encoded audio signal and the additional information into a bitstream.

2. The encoding apparatus of claim 1, wherein
the first frequency band comprises a frequency band having greater energy than the second frequency band.

3. The encoding apparatus of claim 1, wherein
the generating of the embedded audio signal comprises generating the embedded audio signal by folding a spectrum of the second frequency band into the first frequency band based on a boundary frequency of the first frequency band and the second frequency band.

4. The encoding apparatus of claim 1, wherein
the generating of the embedded audio signal comprises, based on energy of frequency bins of the first frequency band, generating the embedded audio signal by embedding the signal components of the second frequency band in at least one bin of the frequency bins.

5. The encoding apparatus of claim 1, wherein
the additional information comprises at least one of first information on frequency bands of the first frequency band and the second frequency band, second information on a frequency bin comprising signal components of the first frequency band and the signal components of the second frequency band, or third information on a degree of mixing of the signal components of the first frequency band and the signal components of the second frequency band.

6. The encoding apparatus of claim 5, wherein
the additional information comprises the at least one information and phase information on the input audio signal.

7. The encoding apparatus of claim 5, wherein
the third information comprises at least one of an energy difference, a phase difference, or a correlation between frequency bands comprising the signal components of the first frequency band and the signal components of the second frequency band.

8. A decoding apparatus comprising:
a memory configured to store instructions; and
a processor electrically connected to the memory and configured to execute the instructions,
wherein the processor is configured to perform a plurality of operations, when the instructions are executed by the processor,
wherein the plurality of operations comprises:
obtaining a bitstream;
parsing an encoded audio signal and additional information associated with a first frequency band and a second frequency band of the encoded audio signal from the bitstream;
generating an embedded audio signal by decoding the encoded audio signal;
separating signal components of the second frequency band embedded in the first frequency band from the embedded audio signal using the additional information; and
generating an output audio signal by synthesizing the signal components separated from the embedded audio signal.

9. The decoding apparatus of claim 8, wherein
the first frequency band comprises a frequency band having greater energy than the second frequency band.

10. The decoding apparatus of claim 8, wherein
the additional information comprises at least one of first information on frequency bands of the first frequency band and the second frequency band, second information on a frequency bin comprising signal components of the first frequency band and the signal components of the second frequency band, or third information on a degree of mixing of the signal components of the first frequency band and the signal components of the second frequency band.

11. The decoding apparatus of claim 10, wherein
the additional information comprises the at least one information and phase information on an original audio signal.

12. The decoding apparatus of claim 10, wherein
the third information comprises at least one of an energy difference, a phase difference, or a correlation between frequency bands comprising the signal components of the first frequency band and the signal components of the second frequency band.

13. The decoding apparatus of claim 12, wherein
the separating comprises dividing energy of the first frequency band and energy of the second frequency band by a ratio of energies.

14. An operating method of an encoding apparatus, the operating method comprising:
obtaining an input audio signal;
generating an embedded audio signal by embedding signal components of a second frequency band of the input audio signal in a first frequency band of the input audio signal;
generating additional information associated with the first frequency band and the second frequency band;
generating an encoded audio signal by encoding the embedded audio signal; and
formatting the encoded audio signal and the additional information into a bitstream.

15. The operating method of claim 14, wherein
the first frequency band comprises a frequency band having greater energy than the second frequency band.

16. The operating method of claim 14, wherein
the generating of the embedded audio signal comprises generating the embedded audio signal by folding a spectrum of the second frequency band into the first frequency band based on a boundary frequency of the first frequency band and the second frequency band.

17. The operating method of claim 14, wherein
the generating of the embedded audio signal comprises, based on energy of frequency bins of the first frequency band, generating the embedded audio signal by embedding the signal components of the second frequency band in at least one bin of the frequency bins.

18. The operating method of claim 14, wherein
the additional information comprises at least one of first information on frequency bands of the first frequency band and the second frequency band, second information on a frequency bin comprising signal components of the first frequency band and the signal components of the second frequency band, or third information on a degree of mixing of the signal components of the first frequency band and the signal components of the second frequency band.

19. The operating method of claim 18, wherein
the additional information comprises the at least one information and phase information on the input audio signal.

20. The operating method of claim 18, wherein
the third information comprises at least one of an energy difference, a phase difference, or a correlation between frequency bands comprising the signal components of the first frequency band and the signal components of the second frequency band.
